(19) United States
(12) Patent Application Publication
(10) Pub. No.: US 2020/0248101 A1
(43) Pub. Date: Aug. 6, 2020

(54) Odor Free Laundry Detergent Soap

(71) Applicant: Michael Alan Thomas, JR., Perkinsville, VT (US)

(72) Inventor: Michael Alan Thomas, JR., Perkinsville, VT (US)

(21) Appl. No.: 16/782,255

(22) Filed: Feb. 5, 2020

Related U.S. Application Data
(60) Provisional application No. 62/801,118, filed on Feb. 5, 2019.

(51) Int. Cl. C11D 3/12; C11D 7/06; C11D 7/44; C11D 9/26; C11D 9/12; C11D 9/16; C11D 11/00; C11D 13/10; C11D 17/08; C11D 3/00

(52) U.S. Cl. CPC C11D 3/1246; C11D 7/06; C11D 7/44; C11D 9/267; C11D 3/0047; C11D 9/16; C11D 11/0017; C11D 13/10; C11D 17/08; C11D 9/12

(57) ABSTRACT

An odor free detergent soap includes Diatomaceous Earth, Olive oil, Borax, Coconut oil, Palm oil, Shea butter, Sodium Hydroxide, Water, Sodium 5 Bicarbonate, Carbon Dioxide and preparation method thereof. Further, the odor free detergent soap is bio-degradable and non-toxic insect killer. The food grade diatomaceous earth is used because it would not harm to the skin and also would not harm to the pet. The odor free laundry detergent soap is good for the washing clothes of people having sensitive skin.

### REFERENCE TO RELATED APPLICATIONS

This application claims the priority of provisional patent application U.S. Ser. No. 62/801,118 filed Feb. 5, 2019 titled Odor Free Laundry Detergent Soap and which is incorporated herein by reference in its entirety.

### FIELD OF THE INVENTION

The present invention generally relates to the field of detergent. The invention, particularly relates to an odor free laundry detergent soap comprising diatomaceous earth, olive oil, borax, coconut oil, palm oil, shea butter, sodium hydroxide, water, sodium bicarbonate, carbon dioxide and preparation method thereof. Further, the odor free detergent soap is bio-degradable and non-toxic insect killer.

### BACKGROUND OF THE INVENTION

A detergent is a surfactant or a mixture of surfactants with cleaning properties in dilute solutions. These substances are usually alkylbenzenesulfonates, a family of compounds that are similar to soap but are more soluble in hard water, because the polar sulfonate (of detergents) is less likely than the polar carboxylate (of soap) to bind to calcium and other ions found in hard water. In most household contexts, the term detergent by itself refers specifically to laundry detergent or dish detergent, as opposed to hand soap or other types of cleaning agents. Detergents are commonly available as powders or concentrated solutions. Detergents, like soaps, work because they are amphiphilic: partly hydrophilic (polar) and partly hydrophobic (non-polar). Their dual nature facilitates the mixture of hydrophobic compounds (like oil and grease) with water. Because air is not hydrophilic, detergents are also foaming agents to varying degrees.

A number of different types of accessories for coloring means are available in prior art. For example, the following patents are provided for their supportive teachings and are all incorporated by reference: Prior art reference, U.S. Pat. No. 7,648,953 discloses a unique eco-friendly liquid laundry detergent enhanced with natural essence and further comprising nonpetroleum source anionic and nonionic surfactants, naturally occurring builders, and optional enzymes, to yield remarkably effective yet environmentally responsible detergents. However, many users of the detergent has allergy over the essence, for them the prior art is not suitable to use.

Another prior art document, U.S. Pat. No. 6,387,856 discloses antimicrobial detergent compositions especially suitable for manual diswashing comprise 0.001-2% iodine ions complexed with an amphoteric surfactant, 5-90% uncomplexed surfactant selected from the group consisting of anionic surfactants, nonionic surfactants, amphoteric surfactants and mixture thereof, and 5-50% water. However, the prior art document is not disclosing the use of detergent for laundry.

Yet another prior art document, U.S. Pat. No. 5,403,506 discloses deodorant detergent compositions comprising a surfactant, e.g., a soap or synthetic detergent, and as a deodorizing component, a minor amount of zinc oxide having an average particle size no greater than about 10 microns. To enhance its deodorizing effect, the composition optionally may contain a minor amount of sodium bicarbonate (SBC). However, the prior art is not disclosing the detergent comprising borax and diatomaceous earth.

Yet another prior art document, EP0379544 discloses fabric cleaning and sanitizing compositions. The compositions include glycol, alcohol, sodium borate, sodium bicarbonate, and acaricidal biocidal cleaning. However, the prior art is not disclosing the detergent comprising borax and diatomaceous earth.

Yet another prior art document, U.S. Pat. No. 5,714,447 discloses deodorant soap or detergent composition containing a zinc compound and a polyamine. A deodorant soap or detergent composition comprising a surfactant, e.g., a soap or synthetic detergent, and either 1) minor but effective amounts in uncomplexed form of a water-insoluble zinc compound, e.g., zinc oxide, and a water-soluble zinc-complexing polyamine which is a polyalkyleneamine or a basic aminoacid polymer; or 2) a water-soluble complex of said water-insoluble zinc compound and said water-soluble zinc-complexing polyamine. However, the prior art is not disclosing the detergent comprising borax and diatomaceous earth.

Yet another non-patent literature prior art document discloses an unscented laundry detergent. The non-patent literature document further discloses a method of preparation of homemade unscented laundry detergent using different types of soaps, for example Dove, Ivory, etc. The unscented laundry detergent also comprises borax and super washing soda (see: https://www.stain-removal-101.com/making-laundry-soap.html). However, the prior art is not disclosing the detergent comprising diatomaceous earth.

Yet another non-patent literature prior art document discloses a preparation method of homemade laundry soap, which can be in liquid or in powder form. The homemade laundry soap comprises soap which is available in the market, borax, and super washing soda. However, the prior art is not disclosing the detergent comprising diatomaceous earth.

However, the above mentioned references and many other similar references has one or more of the following shortcomings: (a) scented detergent; (b) complex processes; (c) only used for dishwashing; (d) laundry detergent not including diatomaceous earth; (e) expensive; and (f) not suitable for insect killing.

The present application addresses the above mentioned concerns and short comings with regard to providing an odor free laundry detergent comprising diatomaceous earth and preparation method thereof.

Other objects and advantages of the present invention will become apparent from the following description taken in connection with the accompanying drawings, wherein is set forth by way of illustration and example, embodiments of this invention.

### SUMMARY OF THE INVENTION

In view of the foregoing disadvantages inherent in the known types of laundry detergent now present in the prior art, the present invention provides an improved odor free laundry detergent soap. As such, the general purpose of the present invention, which will be described subsequently in greater detail, is to provide a new and improved odor free laundry detergent soap having insect killing properties which has all the advantages of the prior art and none of the disadvantages.

An object of the invention is to provide an odor free laundry detergent soap having properties of insect killing. The odor free laundry detergent soap comprises diatomaceous earth compound. The said diatomaceous earth compound is stick to the cloth while laundry, later on when the cloths are drying then the diatomaceous earth is activated. This helps in killing insects from the cloth.

Another object of the invention is to provide the odor free laundry detergent soap comprising Diatomaceous Earth, Olive oil, Borax, Coconut oil, Palm oil, Shea butter, Sodium Hydroxide, Water, Sodium Bicarbonate, and Carbon Dioxide.

Yet another object of the invention is to provide a method of preparation of odor free laundry detergent soap. The inventive preparation method is very simple and easy to follow.

Yet another object is to provide odor free laundry soap having properties of insect killer that provides an insect killer that human and pet friendly way to wash clothes.

Yet another object is to provide odor free laundry soap with an improvement to sanitary cleaning elements for the purpose of washing clothes.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a flow chart of the preparation method of odor free laundry detergent soap according to an embodiment of the present invention.

### DESCRIPTION OF THE PREFERRED EMBODIMENT

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

People with sensitive skin should avoid laundry detergents with fragrance because fragrances are common skin allergens. For people with sensitive skin it is recommended All Free and Clear detergent. Some natural cleaning ingredients like citrus and lavender can be allergens too. Fabric softeners and antistatic drier sheets are loaded with fragrance and should be avoided. To remove all detergent residue from washed clothing it is also recommendation for sensitive skin patients to rinse their cloths twice and avoid packing the washer too full because clothes in an over full washer are not rinsed as well. This same advice generally applies to parents with young children, as babies tend to have sensitive skin and may react negatively to the allergens.

The present invention provides a novel and innovative odor free laundry detergent comprising components for insect killing. The odor free laundry detergent of the present invention comprises different ingredients which are having some beneficial and/or important properties. Some of the main ingredients are:

Diatomaceous Earth

Diatomaceous earth also known as D.E., diatomite,—is a naturally occurring, soft, siliceous sedimentary rock that is easily crumbled into a fine white to off-white powder. It has a particle size ranging from less than 3 μm to more than 1 mm, but typically 10 to 200 μm. Depending on the granularity, this powder can have an abrasive feel, similar to pumice powder, and has a low density as a result of its high porosity. The typical chemical composition of oven-dried diatomaceous earth is 80-90% silica, with 2-4% alumina (attributed mostly to clay minerals) and 0.5-2% iron oxide. It is used as a filtration aid, mild abrasive in products including metal polishes and toothpaste, mechanical insecticide, absorbent for liquids, matting agent for coatings, reinforcing filler in plastics and rubber, anti-block in plastic films, porous support for chemical catalysts, cat litter, activator in blood clotting studies, a stabilizing component of dynamite, and a thermal insulator.

Borax

Sodium borate, sodium tetraborate, or disodium tetraborate used for detergent. Borax, also known as sodium borate, sodium tetraborate, or disodium tetraborate, is an important boron compound, a mineral, and a salt of boric acid. Powdered borax is white, consisting of soft colorless crystals that dissolve in water. This purpose serves as the base of the laundry detergent.

Sodium Bicarbonate

Sodium bicarbonate (IUPAC name: sodium hydrogen carbonate), commonly known as baking soda, is a chemical compound with the formula NaHCO₃. It is a salt composed of sodium ions and bicarbonate ions. Sodium bicarbonate is a white solid that is crystalline but often appears as a fine powder. It has a slightly salty, alkaline taste resembling that of washing soda (sodium carbonate). The natural mineral form is nahcolite. It is a component of the mineral natron and is found dissolved in many mineral springs. Simply, when baking soda (Sodium Bicarbonate) gets heated, it turns into washing soda (Sodium Carbonate)+Carbon Dioxide+Water. A white crystalline compound used in beverages and as a leavening agent to make baked goods. In medicine, sodium bicarbonate is used as an antacid and cleanser and to replenish electrolytes. This chemical combination creates the washing soda.

Sodium Carbonate

Sodium carbonate, Na₂CO₃, (also known as washing soda, soda ash and soda crystals, and in the monohydrate form as crystal carbonate) is the water-soluble sodium salt of carbonic acid. Sodium carbonate is also used as a relatively strong base in various settings. For example, it is used as a pH regulator to maintain stable alkaline conditions. It acts as an alkali because when dissolved in water, it dissociates into the weak acid: carbonic acid and the strong alkali: sodium hydroxide. By far the largest consumption of sodium carbonate is in the manufacture of glass, paper, rayon, soaps, and detergents. It is also used as a water softener, since carbonate can precipitate the calcium and magnesium ions present in “hard” water.

The present invention discloses an odor free detergent soap. The odor free detergent soap comprises diatomaceous earth olive oil, borax, coconut oil, palm oil, shea butter, sodium hydroxide, water, sodium bicarbonate, and carbon dioxide. The odor free detergent soap can be in the liquid form or it can be in semi-liquid or in powder or in solid form. The odor free detergent soap comprises Diatomaceous earth, 18.5 ounces Olive oil; 12 ounces Coconut oil; 9 ounces Palm oil; 1 ounce shea butter; 5.8 ounces Lye (i.e. sodium Hydroxide) and 13.5 ounces water. The presence of diatomaceous earth helps having insect killer properties in the laundry detergent and also provides moisturizing. The coconut oil provides good lather properties. Preferably, the quantity of diatomaceous earth included in any mixture according to the present invention is at a rate of about 2 cups per each 5 gallons of water.

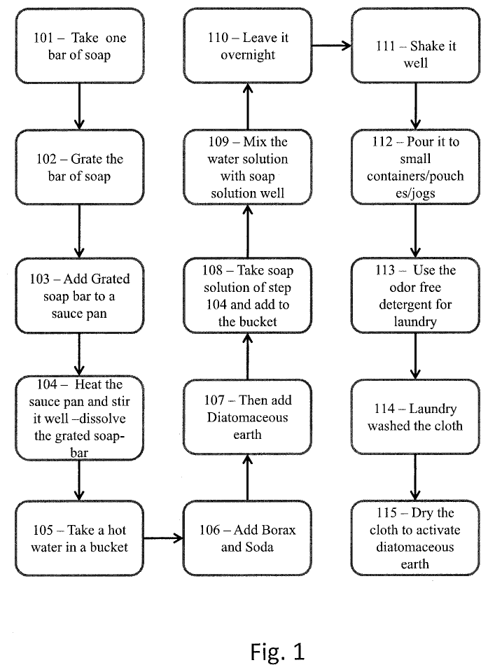

Further, FIG. 1 depicts a flow chart illustrating a method of preparing the odor free laundry detergent soap according to one of the embodiments of the present invention. Step—101—the preparation method of odor free laundry detergent soap starts by selecting and obtaining one bar soap available in the market. The bar soap can be any bar soap used for the bathing purpose, example Dove, Ivory, or any similar one. The bar soap must be odorless. Grating of the bar soap with cheese grater or food processor is performed in the next step 102. Then take a sauce pan and add the grated bar soap and add two quarts of water as shown at step 103. In a next step 104, the mixture of water and grated bar soap is heated with continuous stirring until the bar soap is completely dissolved. Then turn-off the heat and place a clear solution of the bar soap separately. Then put 4.5 gallons of hot water to a 5 gallon bucket as shown at step 105. Add two cups of Borax and two cups of washing soda with stirring to the hot water step 106. Stir the solution till the ingredients are dissolved. In next step 107, add two cups of food grade diatomaceous earth (as described in the mixture above). The food grade diatomaceous earth is used because it would not harm to the skin and also would not harm to the pet. Next take the earlier prepared soap solution, in step 104, in to the five gallon bucket (in which we have solution with all ingredients) step 108. Stir the mixture very well step 109. Next, cover the bucket and leave it for overnight step 110. Then next day, stir the laundry detergent soap solution very well till it becomes smooth step 111. Then pour the laundry detergent soap to the gallon jugs or any small size containers like pouches, jars, pods, etc step 112. The novel odor free laundry detergent can be used now for the laundry purpose. Use ½ cup for smaller loads and 1 cup for larger loads step 113. Then drying of the cloths can be performed either in a dryer or hanging it out to dry step 114. During the drying, the diatomaceous earth is activated. The cloths washed with the odor free laundry detergent soap of the present invention, are very comfortable to the skin and also it provided insect free. The insects are killed by using the odor free laundry detergent soap of the present invention. The odor free laundry detergent soap is exemplified as in the liquid form; however, this can be made in the semi-liquid or powder.

It is understood that additional components may be added to the soap solution that is formed according to the method of manufacturing described above. More particularly, the olive oil, palm oil, coconut oil, shea butter, and the like may be added to the soap solution described above so as to impart the benefits of each.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments. While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. An odor free detergent soap suitable for a laundry purpose, comprising predetermined amounts of diatomaceous earth, olive oil, borax, coconut oil, palm oil, shea butter, sodium hydroxide, water, sodium bicarbonate, and carbon dioxide.

2. The odor free detergent soap of claim 1, comprising 2 cups of diatomaceous earth per 5 gallons of water, 18.5 ounces of olive oil, 12.5 ounces of coconut oil, 9 ounces palm oil, 1 ounce of shea butter, 5.8 ounces of sodium hydroxide, and 13.5 ounces of water.

3. The odor free detergent soap of claim 1, wherein said diatomaceous earth includes particles having a particle size in a range between about 3 μm to more than 1 mm.

4. The odor free detergent soap of claim 1, wherein said diatomaceous earth includes particles having a particle size in a range between about 10 μm to about 200 μm.

5. The odor free detergent soap of claim 4, wherein the borax is taken from a group consisting of sodium borate, sodium tetraborate, and disodium tetraborate.

6. The odor free detergent soap of claim 1, wherein said sodium bicarbonate, when heated becomes a washing soda consisting of sodium carbonate and carbon dioxide and water.

7. The odor free detergent soap of claim 6, wherein said sodium carbonate is a detergent having an alkaline pH.

8. The odor free detergent soap as in claim 1, comprising an aqueous solution having insect killing properties.

9. An odor free detergent soap, comprising one bar of grated bar soap, 2 quarts of water, a clear solution of the bar soap, about 4.5 gallons of hot water, and about 2 cups of diatomaceous earth.

10. The odor free detergent soap of claim 9, wherein the bar soap is odorless bar soap.

11. A method of manufacturing an odor free detergent soap suitable for a laundry purpose, said method comprising:
a) selecting one bar of a bar soap of a type used for bathing and that is odorless;
b) grating said one bar of the bar soap;
c) adding two quarts of water to the grated one bar of the bar soap so as to form a soap solution;
d) heating and stirring the soap solution until the grated one bar of the bar soap is dissolved;
e) adding about 4.5 gallons of hot water to said soap solution; and
f) adding two cups of food grade diatomaceous earth to said soap solution.

12. The method of claim 11, further comprising adding a predetermined amount of olive oil to the soap solution.

13. The method of claim 12, further comprising adding a predetermined amount of coconut oil to the soap solution.

14. The method of claim 13, further comprising adding a predetermined amount of palm oil to the soap solution.

15. The method of claim 14, further comprising adding a predetermined amount of shea butter to the soap solution.
